(19) United States
(12) Patent Application Publication
(10) Pub. No.: US 2026/0279870 A1
(43) Pub. Date: Sep. 17, 2026

(54) CONNECTOR MOUNTING STRUCTURE FOR FUEL CELL STACK

(71) Applicant: HONDA MOTOR CO., LTD., Tokyo (JP)

(72) Inventor: Suguru OMORI, Saitama (JP)

(21) Appl. No.: 19/546,962

(22) Filed: Feb. 23, 2026

(30) Foreign Application Priority Data
Mar. 12, 2025 (JP) 2025-039318

(51) Int. Cl. H01M 8/2404; H01M 8/242; H01R 13/502; H01R 13/627; H01R 13/639; H01R 25/16

(52) U.S. Cl. CPC H01M 8/2404; H01M 8/242; H01R 13/502; H01R 13/6273; H01R 13/639; H01R 25/165

(57) ABSTRACT

A fuel cell stack includes: a receiving recess formed in each bipolar plate to receive a part of the connector; a connection terminal part formed in a bottom portion of the receiving recess; and connector locking parts formed in both side portions of the receiving recess to lock the connector. A connector includes: a housing configured to be insertable into the receiving recess; terminal members held by the housing and configured to be electrically connected to the connection terminal parts; and lock members provided in both side portions of the housing to be capable of protruding and retracting and configured to be engageable with the connector locking parts. At least one grasping mechanism configured to grasp the connector in the state in which the housing is inserted in the receiving recess is provided in the vicinity of the receiving recess of the bipolar plate.

### TECHNICAL FIELD

The present invention relates to a connector mounting structure for a fuel cell stack.

### BACKGROUND ART

In recent years, research and development are being conducted in relation to fuel cells which can contribute to energy efficiency to ensure that a greater number of people can access reliable, sustainable, and advanced energy at reasonable cost.

A fuel cell stack includes multiple cells stacked in a predetermined direction (hereinafter, the first direction). Each cell includes an air electrode, a fuel electrode, a polymer electrolyte membrane disposed between the air electrode and the fuel electrode, and separation plates (separators) disposed on outer sides of the air electrode and the fuel electrode, respectively. The separators of the cells that are adjacent to each other are disposed to overlap in the first direction and are joined to each other to form a bipolar plate.

The fuel cell stack disclosed in JP2021-77616A is provided with a cell-monitoring connector for checking the voltage of each cell. The separation plates of the fuel cell stack are provided with receiving recesses, and the receiving recesses define a receiving space for receiving the cell-monitoring connector in the fuel cell stack. The cell-monitoring connector includes a housing and terminals. When the housing is inserted into the receiving space, the terminals are connected to the separation plates (namely, the bipolar plates), whereby the checking of the voltage of each cell becomes possible. To prevent the cell-monitoring connector from coming off from the fuel cell stack, each bipolar plate is provided with locking parts which are arranged around the receiving recess and have a hook shape. The housing of the cell-monitoring connector is provided with levers that can bend to protrude from the outer surface of the housing, and when the levers are hooked on the locking parts, the cell-monitoring connector is prevented from coming off from the fuel cell stack.

JP7291836B1 discloses a cell-monitoring connector in which the lock members are configured to be easily locked by the locking parts by ensuring an amount of protrusion of each lock member from the housing. This connector includes lock members each provided on the housing to be rotatable about an axis extending in the stacking direction of the separation plates. Due to the structure in which the lock member is configured to rotate to engage with the locking part, compared to the case where the lever is bent to protrude, the connector can be more easily locked by the locking part.

However, in the fuel cell stack, stacking misalignment may occur during manufacture or during use. Therefore, even though the lock member firmly engages with the locking part to be not disengaged from the locking part, there may be play (space) between the lock member and the locking part, and the connector may swing in the stacking direction due to traveling vibration of the vehicle or the like. When the connector swings, the terminal members of the connector may be displaced relative to the connection terminal parts of the bipolar plates, and the connection terminal parts of the bipolar plates and the terminal members of the connector may suffer abrasion.

### SUMMARY OF THE INVENTION

In view of the above problems of the conventional technology, a primary object of the present invention is to provide a connector mounting structure for a fuel cell stack which can suppress abrasion of the connection terminal parts of the bipolar plates and the terminal members of the connector.

To achieve the above object, one aspect of the present invention provides a connector mounting structure for a fuel cell stack, the connector mounting structure comprising: a fuel cell stack formed by alternately stacking membrane-electrode assemblies each composed of an electrolyte membrane and a pair of electrodes disposed on both membrane surfaces and bipolar plates each composed of a pair of plate-shaped separators laminated in a plate thickness direction; and a connector configured to be detachably mounted to the fuel cell stack to detect a power generation state of the fuel cell stack, wherein the fuel cell stack comprises: a receiving recess formed in each bipolar plate to receive a part of the connector; a connection terminal part formed in a bottom portion of the receiving recess; and connector locking parts formed in both side portions of the receiving recess to lock the connector, wherein the connector comprises: a housing configured to be insertable into the receiving recess; terminal members held by the housing and configured to be electrically connected to the connection terminal parts when the housing is inserted in the receiving recess; and lock members provided in both side portions of the housing to be capable of protruding and retracting and configured to be engageable with the connector locking parts in a state in which the housing is inserted in the receiving recess, and wherein at least one grasping mechanism configured to grasp the connector in the state in which the housing is inserted in the receiving recess is provided in vicinity of the receiving recess of the bipolar plate.

According to the above aspect, a connector mounting structure for a fuel cell which can suppress abrasion of the connection terminal parts of the bipolar plates and the terminal members of the connector can be provided.

### BRIEF DESCRIPTION OF THE DRAWINGS

FIG. 1 is a perspective view schematically showing an overall configuration of a fuel cell according to an embodiment;

FIG. 2 is an explanatory diagram of the fuel cell;

FIG. 3 is a front view showing a bipolar plate;

FIG. 4 is an enlarged view of a cell voltage measurement part of the bipolar plate showing a part IV in FIG. 3;

FIG. 5 is a perspective view of a connector before being mounted to the fuel cell;

FIG. 6 is a vertical sectional perspective view of the connector mounted to the fuel cell stack;

FIG. 7 is a sectional view of grasping mechanisms taken along line VII-VII in FIG. 4 and FIG. 6;

FIG. 8 is an enlarged view of a cell voltage measurement part of a bipolar plate according to a modified embodiment;

FIG. 9 is a sectional view of grasping mechanisms taken along line IX-IX in FIG. 8; and

FIG. 10 is a sectional view showing a modification of a widened part of a projecting piece.

### DETAILED DESCRIPTION OF THE INVENTION

In the following, an embodiment of a fuel cell stack 10 will be described with reference to the drawings. Note that in the following description, three orthogonal axes in the front-rear direction, the left-right direction, and the up-down direction are defined as shown in the drawings. However, these directions are for convenience of explanation, and the posture and arrangement of the fuel cell stack 10 according to the present invention are not limited by these directions.

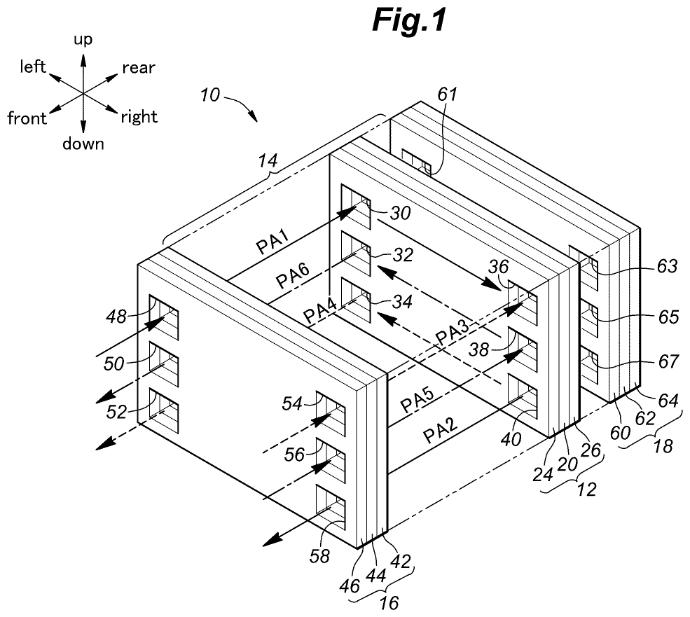

First, an overall structure of the fuel cell stack 10 will be described with reference to FIG. 1. The fuel cell stack 10 is a solid polymer fuel cell stack and includes a cell stack body 14 composed of multiple power generation cells 12 (may be also called fuel cells) stacked in the front-rear direction (predetermined direction). Further, the fuel cell stack 10 includes a wet-side end unit 16 (the first end unit) disposed at one end portion of the cell stack body 14 in the stacking direction and a dry-side end unit 18 (the second end unit) disposed at the other end portion of the cell stack body 14 in the stacking direction. The wet-side end unit 16 and the dry-side end unit 18 are fastened to the cell stack body 14 in the stacking direction by means of fastening members not shown in the drawings, and they are contained in a stack case not shown in the drawings.

The fuel cell stack 10 is supplied with hydrogen gas (fuel gas) and oxidizer gas (air) as reaction gases.

In the following description, the stacking direction of the cell stack body 14 may be referred to as the front-rear direction.

Each power generation cell 12 includes a membrane-electrode assembly (MEA) 20 having a rectangular plate shape and a first separator 24 and a second separator 26 disposed to sandwich the membrane-electrode assembly 20.

The MEA 20 includes an anode electrode 20B, a cathode electrode 20C, and an electrolyte membrane 20A sandwiched by the anode electrode 20B and the cathode electrode 20C. The electrolyte membrane 20A is a film having an insulating property and is composed of an ion exchange membrane which allows hydrogen ions generated at the anode electrode 20B to move to the cathode electrode 20C.

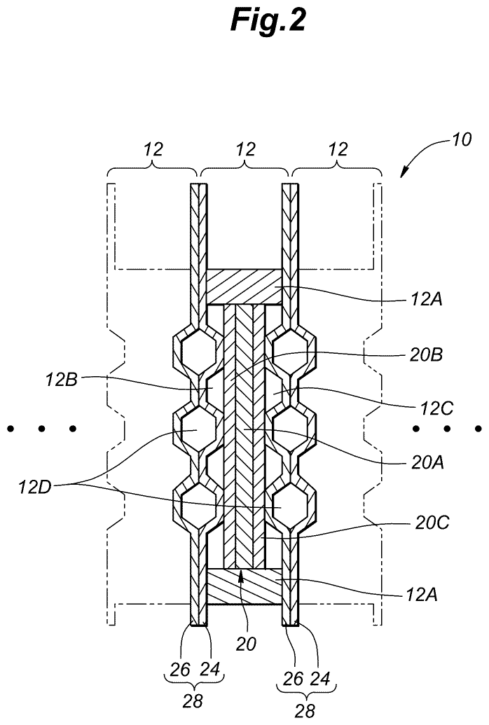

The first separator 24 is an anode-side separator disposed on one side (anode side) of the membrane-electrode assembly 20. The second separator 26 is a cathode-side separator disposed on the other side (cathode side) of the membrane-electrode assembly 20. The first separator 24 and the second separator 26 are formed of metal plates with an uneven surface obtained by press working. The first separator 24 and the second separator 26 that respectively belong to adjacent power generation cells 12 and are themselves adjacent to each other are joined to each other to form a bipolar plate 28 (see FIG. 2).

A left edge part of each power generation cell 12 is formed with a hydrogen gas supply opening 30, a coolant discharge opening 32, and an oxidizer gas discharge opening 34 arranged in order from above and each extending through the power generation cell 12 in the stacking direction. A right edge part of each power generation cell 12 is formed with an oxidizer gas supply opening 36, a coolant supply opening 38, and a hydrogen gas discharge opening 40 arranged in order from above and each extending through the power generation cell 12 in the stacking direction.

As shown in FIG. 2, the membrane-electrode assembly 20 includes an electrolyte membrane 20A, which is a proton conductor, an anode electrode 20B provided on one side of the electrolyte membrane 20A, and a cathode electrode 20C provided on the other side of the electrolyte membrane 20A. Also, each power generation cell 12 includes a frame member 12A along an outer periphery of the electrolyte membrane 20A, the anode electrode 20B, and the cathode electrode 20C. The frame member 12A is preferably made of insulating resin or the like.

The first separator 24 defines, between itself and a surface of the membrane-electrode assembly 20 on the side of the anode electrode 20B, a hydrogen gas passage 12B which is a passage for supplying hydrogen gas. Also, the first separator 24 contacts the anode electrode 20B and is electrically connected to the anode electrode 20B. The second separator 26 defines an oxidizer gas passage 12C between itself and a surface of the membrane-electrode assembly 20 on the side of the cathode electrode 20C. Also, the second separator 26 contacts the cathode electrode 20C and is electrically connected to the cathode electrode 20C. In the state in which the power generation cells 12 are stacked, a coolant passage 12D for circulation of the coolant is defined between each pair of the first separator 24 and the second separator 26 that are adjacent to each other.

The wet-side end unit 16 includes a terminal plate 42, an electrical insulation plate 44, and an end plate 46 which are stacked in order from the side of the power generation cells 12. A left edge part of the wet-side end unit 16 is formed with a hydrogen gas supply opening 48, a coolant discharge opening 50, and an oxidizer gas discharge opening 52 arranged in order from above and each extending through the wet-side end unit 16 in the front-rear direction. A right edge part of the wet-side end unit 16 is formed with an oxidizer gas supply opening 54, a coolant supply opening 56, and a hydrogen gas discharge opening 58 arranged in order from above and each extending through the wet-side end unit 16 in the front-rear direction. The openings provided in the wet-side end unit 16 are in the same arrangement as the openings provided in each power generation cell 12 and each communicate with a corresponding one of the hydrogen gas supply opening 30, the hydrogen gas discharge opening 40, the oxidizer gas supply opening 36, the oxidizer gas discharge opening 34, the coolant supply opening 38, and the coolant discharge opening 32 of the power generation cell 12.

The hydrogen gas supply opening 48 communicates with the hydrogen gas supply opening 30 of the power generation cell 12. The coolant discharge opening 50 communicates with the coolant discharge opening 32 of the power generation cell 12. The oxidizer gas discharge opening 52 communicates with the oxidizer gas discharge opening 34 of the power generation cell 12. The oxidizer gas supply opening 54 communicates with the oxidizer gas supply opening 36 of the power generation cell 12. The coolant supply opening 56 communicates with the coolant supply opening 38 of the power generation cell 12. The hydrogen gas discharge opening 58 communicates with the hydrogen gas discharge opening 40 of the power generation cell 12.

The dry-side end unit 18 includes a terminal plate 60, an electrical insulation plate 62, and an end plate 64 which are stacked in order from the side of the power generation cells 12. The terminal plate 60 and the electrical insulation plate 62 are formed with a hydrogen gas supply opening 61, a hydrogen gas discharge opening 67, an oxidizer gas supply opening 63, an oxidizer gas discharge opening (not shown in the drawings), a coolant supply opening 65, and a coolant discharge opening (not shown in the drawings) arranged in the same manner as the openings of the wet-side end unit 16 and each extending through the terminal plate 60 and the electrical insulation plate 62 in the front-rear direction. Note that the end plate 64 is not formed with these openings. The openings provided in the dry-side end unit 18 are in the same arrangement as the openings provided in each power generation cell 12 and each communicate with a corresponding one of the hydrogen gas supply opening 30, the hydrogen gas discharge opening 40, the oxidizer gas supply opening 36, the oxidizer gas discharge opening 34, the coolant supply opening 38, and the coolant discharge opening 32 of the power generation cell 12.

Thereby, the hydrogen gas flows in the stacking direction of the cell stack body 14 through a gas supply flow path PA1 to be supplied to hydrogen gas passages 12B (FIG. 2) of each power generation cell 12. The hydrogen off-gas (exhaust gas) generated at each power generation cell 12 flows from each power generation cell 12 in the stacking direction of the cell stack body 14 through an exhaust gas flow path PA2.

The oxidizer gas may be air and flows in the stacking direction of the cell stack body 14 through a gas supply flow path PA3 to be supplied to oxidizer gas passages 12C (FIG. 2) of each power generation cell 12. The oxidizer off-gas (exhaust gas) generated at each power generation cell 12 flows from each power generation cell 12 in the stacking direction of the cell stack body 14 through an exhaust gas flow path PA4.

The coolant (cooling medium) may be a liquid including water or the like and flows in the stacking direction of the cell stack body 14 through a coolant supply flow path PA5 to be supplied to coolant passages 12D (FIG. 2) formed on the front and rear sides of each power generation cell 12 to cool each power generation cell 12. The coolant discharged from each power generation cell 12 flows in the stacking direction of the cell stack body 14 through a coolant discharge flow path PA6 (cooling medium discharge flow path).

In the fuel cell stack 10, electron and water are generated by the electrochemical reaction of the hydrogen gas and the oxidizer gas supplied to each power generation cell 12, and electric power is taken out from the terminal plates 42 and 60. The water generated in the fuel cell stack 10 is discharged to the outside of the fuel cell stack 10 through the exhaust gas flow paths PA2 and PA4.

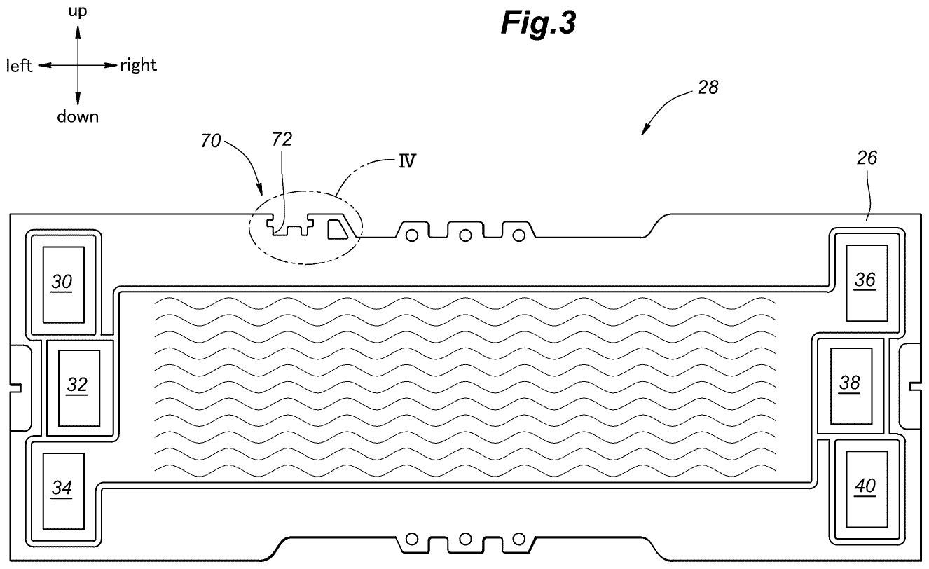

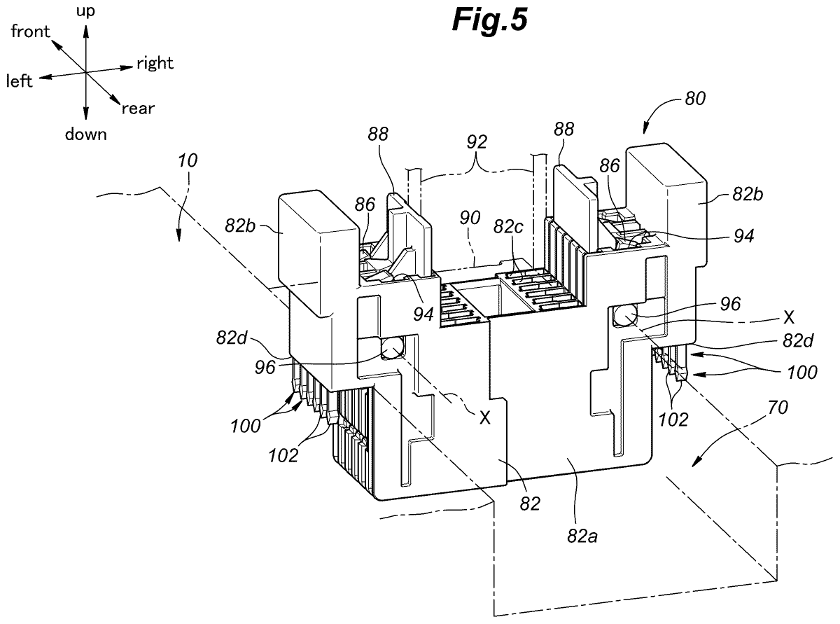

FIG. 3 is a front view showing the bipolar plate 28. As shown in FIG. 3, an upper edge of the bipolar plate 28 is formed with a cell voltage measurement part 70 for measuring the voltage of each power generation cell 12. The cell voltage measurement part 70 is provided to measure the voltage between the pair of bipolar plates 28 that are adjacent to each other via the membrane-electrode assembly 20. The cell voltage measurement part 70 is formed, by cutting out a part of the bipolar plate 28, as a receiving recess 72 that is recessed downward to be able to receive a part of the connector 80 (see FIG. 5).

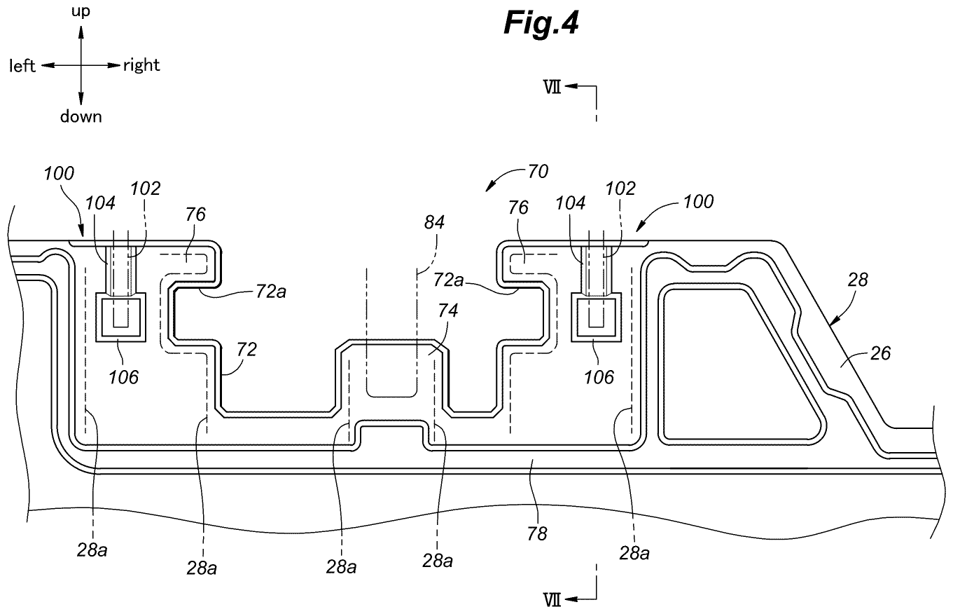

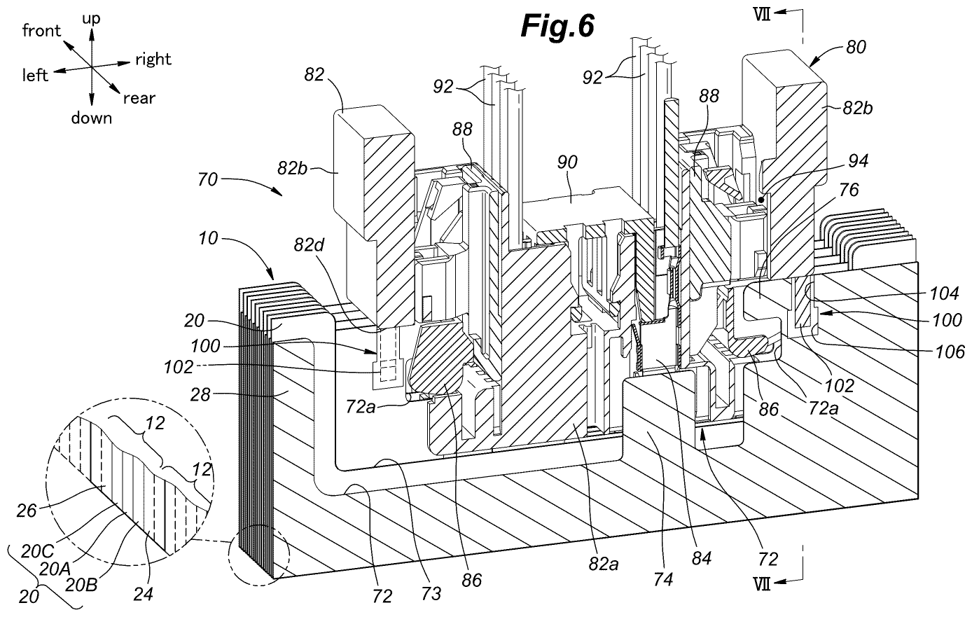

FIG. 4 is an enlarged view of the cell voltage measurement part 70 of the bipolar plate 28 showing a part IV in FIG. 3, FIG. 5 is a perspective view of the connector 80 before being mounted to the fuel cell stack 10, and FIG. 6 is a vertical sectional perspective view of the connector 80 mounted to the fuel cell stack 10. As shown in FIG. 4, the cell voltage measurement part 70 of the bipolar plate 28 is provided with a receiving recess 72, a connection terminal part 74 formed in a bottom portion of the receiving recess 72, connector locking parts 76 formed in both side portions of the receiving recess 72, and reinforcement ribs 78.

The connection terminal part 74 is a part to which a terminal (terminal member 84) of the connector 80 (FIG. 5) used in the voltage measurement is electrically connected. The connection terminal part 74 is composed of a rectangular section (tab) protruding upward in FIG. 3 from the bottom portion of the receiving recess 72. The connection terminal part 74 is formed by integrally joining, by welding, a tab-shaped anode-side section and a tab-shaped cathode-side section respectively formed in the first separator 24 and the second separator 26 that form the bipolar plate 28.

The parts where the first separator 24 and the second separator 26 are joined are referred to as joining parts 28a of the bipolar plate 28. In other words, the bipolar plate 28 is integrally welded at the joining parts 28a. The joining parts 28a are provided at both edge parts of the connection terminal part 74 to extend along the connection direction of the connector terminal (the up-down direction in FIG. 4). Note that in the present embodiment, the connector 80 is configured such that a lower portion of a housing 82, which forms a main body of the connector 80, is inserted into and removed out of the receiving recess 72 along the up-down direction. In other words, the housing 82 of the connector 80 is configured to be insertable into the receiving recess 72.

No joining part 28a is provided at the tip edge part of the connection terminal part 74, so that the trajectory of the sliding contact of the terminal member 84 when assembling the connector 80 does not overlap the joining parts 28a.

The connector locking parts 76 are provided so as to engage with the connector 80 in a state in which the terminal member 84 of the connector 80 is connected to the connection terminal part 74, thereby holding the assembled state of the connector 80. Cutouts 72a are formed in both side portions of the receiving recess 72, and the connector locking parts 76 constitute side wall portions above the cutouts 72a. As will be described later, lock members 86 (see FIG. 6) supported by the housing 82 of the connector 80 engage with the cutouts 72a in the both side portions of the receiving recess 72.

The reinforcement ribs 78 are formed along a periphery of each bipolar plate 28 to pass around the cell voltage measurement part 70. The reinforcement ribs 78 are provided on both the first separator 24 and the second separator 26 forming each bipolar plate 28 and protrude in the stacking direction (plate thickness direction) toward the adjacent bipolar plates 28 (namely, the reinforcement rib 78 on the first separator 24 and the reinforcement rib 78 on the second separator protrude in directions away from each other), such that each reinforcement rib 78 has a substantially trapezoidal convex shape in cross section. Thus, each reinforcement rib 78 on the first separator 24 and the corresponding reinforcement rib 78 on the second separator 26 jointly form a hexagonal hollow cross section.

As shown in FIG. 5, the connector 80 according to the present invention is mounted to the fuel cell stack 10. As shown in FIG. 6, each bipolar plate 28 is formed with a receiving recess 72 that is recessed inward, and each membrane-electrode assembly 20 is also formed with an assembly recess 73 overlapping with the receiving recess 72 in the stacking direction. The receiving recesses 72 of the multiple bipolar plates 28 and the multiple assembly recesses 73 of the membrane-electrode assemblies 20 form a receiving groove that extends in the front-rear direction, and the receiving groove defines a receiving space into which the connector 80 is removably inserted.

Next, the structure of the connector 80 will be described.

As shown in FIG. 5 and FIG. 6, the connector 80 includes a housing 82, terminal members 84 (see FIG. 6), lock members 86, and levers 88.

The housing 82 is a member made of resin and is configured such that at least a part thereof can be removably inserted into the receiving recess 72 from above. The housing 82 includes a housing main body 82a constituting the central part thereof and having a substantially rectangular parallelepiped shape and housing side portions 82b provided on both the left and right sides of the housing main body 82a.

The housing main body 82a is provided with multiple terminal holes 82c (FIG. 5) each extending in the up-down direction. In the present embodiment, the housing main body 82a is provided with pairs of left and right terminal holes 82c arranged in the front-rear direction.

The terminal members 84 are each composed of a member made of metal. The terminal members 84 are respectively inserted into the terminal holes 82c and are held in the housing main body 82a. In the present embodiment, a retainer 90 made of resin is inserted into the housing main body 82a from the rear, whereby detachment of the terminal members 84 from the housing main body 82a is prevented.

The terminal members 84 are respectively connected to wires 92. When the connector 80 is inserted into the receiving recess 72, the terminal members 84 respectively contact the connection terminal parts 74 of the bipolar plates 28. The voltage generated by each power generation cell 12 can be acquired by measuring the electric potential difference between the wires 92 of the associated terminal members 84.

Each of the housing side portions 82b is formed with a lock member receiving part 94 that is recessed downward from the upper end thereof. The lock member receiving part 94 is a recess in a quadrangular prism shape and extends downward.

In the present embodiment, the housing side portions 82b are respectively provided on the left and right side portions of the housing main body 82a. Each of the housing side portions 82b has a shoulder surface 82d facing downward and positioned higher than the lower edge of the housing main body 82a (namely, spaced from the lower edge of the housing main body 82a in the direction opposite to the insertion direction). In the state in which the connector 80 is inserted in the receiving recess 72, the shoulder surfaces 82d of the housing side portions 82b face an outer edge of the bipolar plate 28, which, in the present embodiment, is the upper edge of the bipolar plate 28.

The lock members 86 are members made of resin. In the present embodiment, as shown in FIG. 5, the lock members 86 are respectively provided at both left and right ends of the housing 82, namely, at both end portions in a direction perpendicular to the downward direction, which is the insertion direction of the connector 80, and perpendicular to the stacking direction of the power generation cells 12 (the front-rear direction).

As shown in FIG. 5, each lock member 86 is provided with a cylindrical columnar shaft part 96 extending in the stacking direction of the power generation cells 12 (the front-rear direction) and is received in the lock member receiving part 94 in a state in which the shaft part 96 is supported by the housing 82 via a bearing. Thereby, each lock member 86 is supported by the housing 82 to be rotatable about an axis X extending in the front-rear direction (the stacking direction).

As shown in FIGS. 5 and 6, at a lower edge of each of the left and right wall portions of the housing main body 82a, through holes extending therethrough in the left-right direction are provided. By rotating about the axis X, each lock member 86 is displaceable between a retracted position in which it is retracted into the inside of the housing 82 and a protruding position in which it protrudes to the outside of the housing 82.

The levers 88 are members made of resin and, as shown in FIG. 5, are configured to be capable of being respectively inserted into the left and right lock member receiving parts 94 from above. In this way, since the levers 88 are configured to be capable of being inserted into the corresponding lock member receiving parts 94 in which the lock members 86 are received, it is possible to convert the pressing force due to the insertion of the levers 88 or the pull-out force and to rotate the lock members 86.

When the lock members 86 are displaced to the protruding position in which they protrude to the outside of the housing 82, the lock members 86 enter the cutouts 72a of the corresponding receiving recesses 72 to be engageable with the connector locking parts 76 positioned above the cutouts 72a.

The lock members 86 have a known configuration, and therefore, details of the operation thereof will not be described here. For details of the operation, refer to JP7291836B1 of which the Applicant is a joint owner.

As described above, since the connector 80 is provided with the lock members 86 and the levers 88, the connector 80 is prevented from being inadvertently detached from the fuel cell stack 10. However, the connector 80 may swing due to traveling vibration of the vehicle in which the fuel cell stack 10 is installed or vibrations of other devices. Specifically, since the center of gravity of the connector 80 is located higher than the connection part between each terminal member 84 and the associated connection terminal part 74 and the connection part serves as a fulcrum of the connector 80, the connector 80 swings in the stacking direction of the power generation cells 12 (the front-rear direction) about the fulcrum. At the central part of the connector 80 in the front-rear direction, the amount of sliding between the terminal members 84 and the connection terminal parts 74 is small, but the amount of sliding between the terminal members 84 and the connection terminal parts 74 increases toward the end portion of the connector 80 in the front-rear direction. Therefore, there was a problem that at the end portion of the connector 80 in the front-rear direction, the terminal members 84 and the connection terminal parts 74 may suffer abrasion due to sliding between the terminal members 84 and the connection terminal parts 74.

To solve such a problem, in the present embodiment, grasping mechanisms 100 configured to grasp the connector 80 in the state in which the housing 82 of the connector 80 is inserted in the receiving recess 72 are provided in the vicinity of the receiving recess 72 of each bipolar plate 28. Due to such a connector mounting structure, the swinging of the connector 80 is suppressed, and the abrasion of the connection terminal parts 74 of the bipolar plates 28 and the terminal members 84 of the connector 80 is suppressed. Detailed description will be provided below.

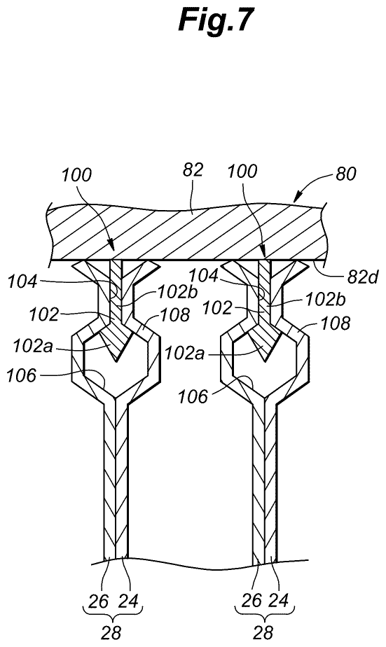

The grasping mechanisms 100 will be described with reference to FIG. 4 to FIG. 7. FIG. 7 is a sectional view of the grasping mechanisms 100 taken along line VII-VII in FIG. 4 and FIG. 6. As shown in FIG. 5 and FIG. 6, the housing 82 of the connector 80 is provided with projecting pieces 102 projecting from the shoulder surface 82d of each housing side portion 82b. The projecting pieces 102 are provided on each of the left and right side portions of the housing 82 at multiple positions spaced in the stacking direction of the power generation cells 12 (the front-rear direction). Thereby, swinging of the connector 80 is suppressed more effectively.

The projecting pieces 102 have the same structure. The projecting pieces 102 may be made of resin integrally with the housing 82 or may be made of a material different from the housing 82 and be held on the housing 82. The projecting pieces 102 are arranged in the front-rear direction at an interval corresponding to the interval of the bipolar plate 28. The projecting pieces 102 may be provided for each bipolar plate 28 or may be provided for every other bipolar plate 28.

As shown in FIG. 4 and FIG. 7, each bipolar plate 28 is formed with introduction passages 104 that open in the upper edge thereof to allow the projecting pieces 102 to enter therein when the connector 80 is inserted in the receiving recess 72. Each introduction passage 104 is formed between a pair of the first separator 24 and the second separator 26 by ridges formed on the first separator 24 and the second separator 26 such that each ridge protrudes inward to have a trapezoidal cross section. At the lower end of each introduction passage 104, a pouch-like part 106 that is widened relative to the introduction passage 104 in the plate thickness direction (the front-rear direction) is formed. Each pouch-like part 106 is formed between a pair of the first separator 24 and the second separator 26 by protrusions formed on the first separator 24 and the second separator 26 such that each protrusion protrudes outward to have a trapezoidal cross section.

As shown in FIG. 7, each projecting piece 102 has a widened part 102a that is widened in the front-rear direction at the tip thereof. The widened part 102a is widened both forward and rearward relative to the part of the p rojecting piece 102 other than the widened part 102a, namely, the part connecting the widened part 102a and the shoulder surface 82d of the housing 82 (hereinafter referred to as the connecting part 102b). The widened part 102a has a tapered shape that becomes narrower toward the lower end (the tip). Also, the widened part 102a has a kite shape that becomes narrower toward the top (toward the connecting part 102b).

The thickness of the connecting part 102b of the projecting piece 102 is about the same as the width (the dimension in the front-rear direction) of the introduction passage 104. On the other hand, the thickness of the widened part 102a of the projecting piece 102 is greater than the width of the introduction passage 104 and smaller than the width (the dimension in the front-rear direction) of the pouch-like part 106. The projecting piece 102 is inserted in the introduction passage 104 and is grasped by the pair of the first separator 24 and the second separator 26. Thereby, separation of the shoulder surface 82d of the housing 82 from the outer edge of the bipolar plate 28 is restricted, and swinging of the connector 80 is suppressed.

The widened part 102a of the projecting piece 102 is disposed in the pouch-like part 106 when the connector 80 is inserted in the receiving recess 72. Therefore, a large force is necessary when the widened part 102a comes out of the pouch-like part 106 to the introduction passage 104. Thereby, swinging of the connector 80 is effectively suppressed.

The first separator 24 and the second separator 26 are provided with a pair of inclined wall portions 108 that are inclined to make the pouch-like part 106 narrower toward the introduction passage 104 at the part of the pouch-like part 106 on the inlet side, namely, on the side of the introduction passage 104. The widened part 102a of the projecting piece 102 is clamped by the pair of inclined wall portions 108 when the connector 80 is inserted in the receiving recess 72. Thereby, the widened part 102a is prevented from moving toward the introduction passage 104 in addition to being prevented from coming out of the pouch-like part 106 to the introduction passage 104. Accordingly, swinging of the connector 80 is effectively suppressed.

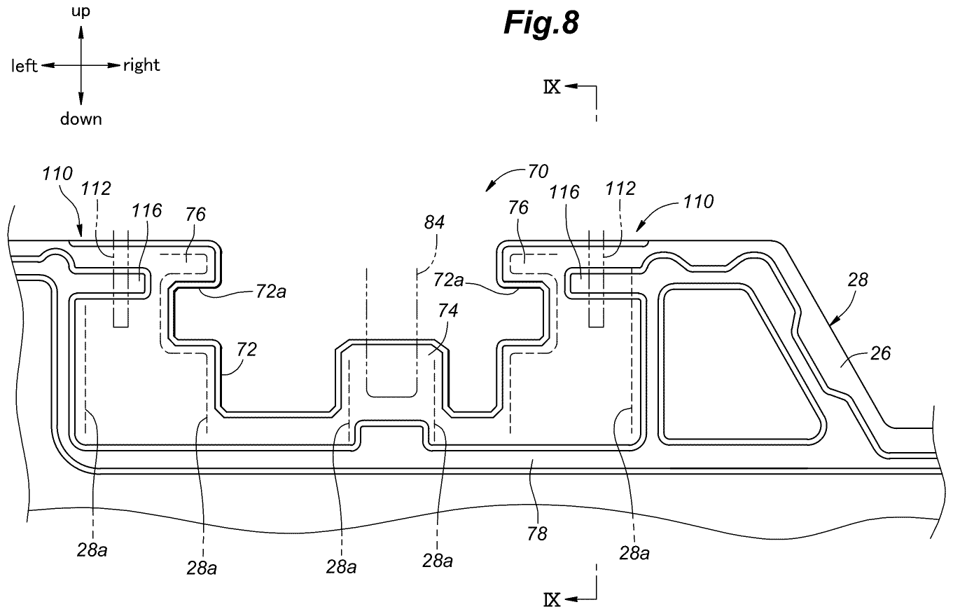

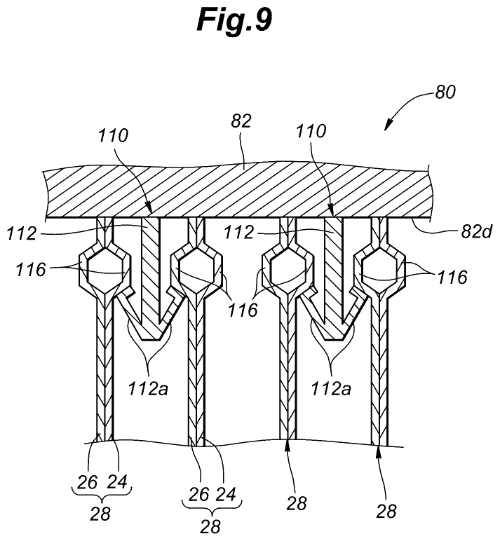

Next, with reference to FIG. 8 and FIG. 9, a connector mounting structure according to a modified embodiment will be described. This embodiment differs from the above embodiment with respect to the configuration of grasping mechanisms 110 configured to grasp the connector 80 in the state in which the connector 80 is inserted in the receiving recess 72. Note that the features same as or similar to those of the above embodiment will be denoted by the same reference signs and redundant description will be omitted.

FIG. 8 is an enlarged view of the cell voltage measurement part 70 of the bipolar plate 28 according to a modified embodiment and corresponds to FIG. 4. FIG. 9 is a sectional view of grasping mechanisms 110 taken along line IX-IX in FIG. 8 and corresponds to FIG. 7.

As shown in FIG. 8 and FIG. 9, to form the grasping mechanisms 110, the housing 82 of the connector 80 is provided with projecting pieces 112 projecting from the shoulder surface 82d. When the housing 82 is inserted in the receiving recess 72, each projecting piece 112 is grasped by a pair of bipolar plates 28 that are adjacent to each other. Thereby, separation of the shoulder surface 82d of the housing 82 from the outer edge of the bipolar plate 28 is restricted, and swinging of the connector 80 is suppressed.

The pair of bipolar plates 28 are formed, in the vicinity of the outer edges thereof, with protruding ribs 116 that protrude so as to reduce the distance therebetween. Specifically, the first separator 24 and the second separator 26 of each bipolar plate 28 are formed with protruding ribs 116 that protrude in the direction away from each other (outward) along the upper edge of the bipolar plate 28. As shown in FIG. 8, the protruding ribs 116 are formed on both the left and right sides of the receiving recess 72. The protruding ribs 116 have a configuration similar to that of the reinforcement rib 78. In the present embodiment, the protruding ribs 116 are connected to the reinforcement rib 78 and are formed to extend from the reinforcement rib 78 toward the receiving recess 72.

As shown in FIG. 9, each projecting piece 112 is provided in a position corresponding to a space between a pair of bipolar plates 28 that are adjacent to each other. Each projecting piece 112 is provided with at least one widened part 112a that is widened in the front-rear direction at the tip thereof. In the present embodiment, a pair of widened parts 112a are provided to protrude forward and rearward of the projecting piece 112. The thickness of the pair of widened parts 112a is greater than the width (the dimension in the front-rear direction) between the protruding ribs 116 of the pair of bipolar plates 28 that are adjacent to each other. When the housing 82 is inserted in the receiving recess 72, the pair of widened parts 112a are disposed on the inner side (lower side) of the pair of protruding ribs 116 and engage with the pair of protruding ribs 116. Namely, the pair of widened parts 112a are clamped by the pair of protruding ribs 116. Thereby, separation of the shoulder surface 82d of the housing 82 from the outer edge of the bipolar plate 28 is restricted, and swinging of the connector 80 is suppressed.

The widened parts 112a of the present embodiment are configured as elastic claws extending from the tip of the projecting piece 112 in an inclined manner to be more separated from each other toward the base end. Thereby, while the insertion of the projecting piece 112 between the bipolar plates 28 is easy, the projecting piece 112 is effectively prevented from slipping out from between the bi polar plates 28.

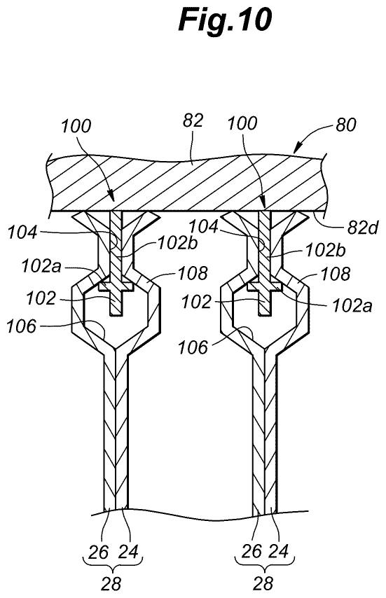

Concrete embodiments have been described in the foregoing, but the present invention can be modified in various ways without being limited by the above configurations. For example, though the widened part 102a of the projecting piece 102 shown in FIG. 7 has a kite shape, it may have a cross shape as shown in FIG. 10 or may have a straight line shape that protrudes in the front-rear direction from the connecting part 102b of the projecting piece 102. Also, the widened parts 112a of the projecting piece 112 shown in FIG. 9 may have a kite shape shown in FIG. 7, a cross shape shown in FIG. 10, or a straight line shape.

Also, the concrete structure, arrangement, number, etc. of each member or part may be appropriately changed within the spirit of the present invention. Further, the configurations of the above embodiments may be combined partially or as a whole. Also, not all of the components shown in the foregoing embodiments are necessarily indispensable and they may be selectively adopted as appropriate.

The above embodiments may be summarized as follows.

One embodiment is a connector mounting structure for a fuel cell stack, the connector mounting structure comprising: a fuel cell stack 10 formed by alternately stacking membrane-electrode assemblies 20 each composed of an electrolyte membrane 20A and a pair of electrodes (the anode electrode 20B and the cathode electrode 20C) disposed on both membrane surfaces and bipolar plates 28 each composed of a pair of plate-shaped separators (the first separator 24 and the second separator 26) laminated in a plate thickness direction; and a connector 80 configured to be detachably mounted to the fuel cell stack 10 to detect a power generation state of the fuel cell stack 10. The fuel cell stack 10 comprises: a receiving recess 72 formed in each bipolar plate 28 to receive a part of the connector 80; a connection terminal part 74 formed in a bottom portion of the receiving recess 72; and connector locking parts 76 formed in the both side portions of the receiving recess 72 to lock the connector 80. The connector 80 comprises: a housing 82 configured to be insertable into the receiving recess 72; terminal members 84 held by the housing 82 and configured to be electrically connected to the connection terminal parts 74 when the housing 82 is inserted in the receiving recess 72; and lock members 86 provided in both side portions of the housing 82 to be capable of protruding and retracting and configured to be engageable with the connector locking parts 76 in a state in which the housing 82 is inserted in the receiving recess 72. At least one grasping mechanism 100, 110 configured to grasp the connector 80 in the state in which the housing 82 is inserted in the receiving recess 72 is provided in vicinity of the receiving recess 72 of the bipolar plate 28.

According to this aspect, since the connector 80 is grasped by the grasping mechanism 100, 110, swinging of the connector 80 is suppressed. Therefore, abrasion of the connection terminal parts 74 of the bipolar plates 28 and the terminal members 84 of the connector 80 is suppressed.

In the above aspect, preferably, the at least one grasping mechanism 100, 110 is provided on both sides of the receiving recess 72 of the bipolar plate 28.

According to this aspect, compared to a case where the at least one grasping mechanism 100, 110 is provided on one side of the receiving recess 72, swinging of the connector 80 is suppressed more effectively.

In the above aspect, preferably, the at least one grasping mechanism 100, 110 is provided in multiple positions in the plate thickness direction.

According to this aspect, compared to a case where the at least one grasping mechanism 100, 110 is provided in one position in the plate thickness direction, swinging of the connector 80 is suppressed more effectively.

In the above aspect, preferably, the housing 82 has shoulder surfaces 82d configured to be disposed to face outer edges of the bipolar plate 28 on both side portions of the receiving recess 72 in a state in which the housing is inserted in the receiving recess 72, and the at least one grasping mechanism 100 includes a projecting piece 102 provided on the housing 82 to project from one of the shoulder surfaces 82d and configured to be grasped by a pair of the first separator 24 and the second separator 26 when the housing 82 is inserted in the receiving recess 72.

According to this aspect, due to the projecting piece 102 grasped by the first separator 24 and the second separator 26, separation of the shoulder surface 82d of the housing 82 from the outer edge of the bipolar plate 28 is restricted. Thereby, swinging of the connector 80 is suppressed.

In the above aspect, preferably, the pair of the first separator 24 and the second separator 26 are formed with an introduction passage 104 that opens in an outer edge to allow the projecting piece 102 to enter between the first separator 24 and the second separator 26 and a pouch-like part 106 to which the introduction passage 104 is connected and which is widened in the plate thickness direction relative to the introduction passage 104, and the projecting piece 102 is provided with a widened part 102a configured to be disposed in the pouch-like part 106 when the housing 82 is inserted in the receiving recess 72.

According to this aspect, a large force is required when the widened part 102a comes out of the pouch-like part 106 to the introduction passage 104, and thus, swinging of the connector 80 is effectively suppressed.

In the above aspect, preferably, the widened part 102a is configured to be clamped by a pair of inclined wall portions 108 formed on an inlet side of the pouch-like part 106 when the housing 82 is inserted in the receiving recess 72.

According to this aspect, since the widened part 102a is clamped by the pair of inclined wall portions 108, the pouch-like part 106 is prevented from moving toward the introduction passage 104 in addition to being prevented from coming out to the introduction passage 104. Thereby, swinging of the connector 80 is effectively suppressed.

In the above aspect, preferably, the housing 82 has shoulder surfaces 82d configured to face an outer edge of the bipolar plate 28 on both side portions of the receiving recess 72 in a state in which the housing 82 is inserted in the receiving recess 72, and the at least one grasping mechanism 110 includes a projecting piece 112 provided on the housing 82 to project from one of the shoulder surfaces 82d and configured to be grasped by a pair of the bipolar plates 28 that are adjacent to each other when the housing 82 is inserted in the receiving recess 72.

According to this aspect, due to the projecting piece 112 provided to project from the shoulder surface 82d of the housing 82 and configured to be grasped by the pair of bipolar plates 28 that are adjacent to each other, separation of the shoulder surface 82d of the housing 82 from the outer edge of the bipolar plate 28 is restricted. Thereby, swinging of the connector 80 is suppressed.

In the above aspect, preferably, the pair of bipolar plates 28 are formed with protruding ribs 116 that protrude so as to reduce a distance therebetween in vicinity of outer edges thereof, and the projecting piece 112 is provided with a widened part 112a configured to be disposed on an inner side of the protruding ribs 116 and to engage with the protruding ribs 116 when the housing 82 is inserted in the receiving recess 72.

According to this aspect, the widened part 112a engages with and is clamped by the pair of protruding ribs 116, whereby the widened part 112a is prevented from moving in the withdrawal direction in addition to being prevented from coming out over the protruding ribs 116. Thereby, swinging of the connector 80 is effectively suppressed.

1. A connector mounting structure for a fuel cell stack, the connector mounting structure comprising:
a fuel cell stack formed by alternately stacking membrane-electrode assemblies each composed of an electrolyte membrane and a pair of electrodes disposed on both membrane surfaces and bipolar plates each composed of a pair of plate-shaped separators laminated in a plate thickness direction; and
a connector configured to be detachably mounted to the fuel cell stack to detect a power generation state of the fuel cell stack,
wherein the fuel cell stack comprises:
a receiving recess formed in each bipolar plate to receive a part of the connector;
a connection terminal part formed in a bottom portion of the receiving recess; and
connector locking parts formed in both side portions of the receiving recess to lock the connector,
wherein the connector comprises:
a housing configured to be insertable into the receiving recess;
terminal members held by the housing and configured to be electrically connected to the connection terminal parts when the housing is inserted in the receiving recess; and
lock members provided in both side portions of the housing to be capable of protruding and retracting and configured to be engageable with the connector locking parts in a state in which the housing is inserted in the receiving recess,
and wherein at least one grasping mechanism configured to grasp the connector in the state in which the housing is inserted in the receiving recess is provided in vicinity of the receiving recess of the bipolar plate.

2. The connector mounting structure according to claim 1, wherein the at least one grasping mechanism is provided on both sides of the receiving recess of the bipolar plate.

3. The connector mounting structure according to claim 1, wherein the at least one grasping mechanism is provided in multiple positions in the plate thickness direction.

4. The connector mounting structure according to claim 1, wherein the housing has shoulder surfaces configured to be disposed to face outer edges of the bipolar plate on both side portions of the receiving recess in a state in which the housing is inserted in the receiving recess, and
the at least one grasping mechanism includes a projecting piece provided on the housing to project from one of the shoulder surfaces and configured to be grasped by a pair of the separators when the housing is inserted in the receiving recess.

5. The connector mounting structure according to claim 4, wherein the pair of the separators are formed with an introduction passage that opens in an outer edge to allow the projecting piece to enter between the separators and a pouch-like part to which the introduction passage is connected and which is widened in the plate thickness direction relative to the introduction passage, and
the projecting piece is provided with a widened part configured to be disposed in the pouch-like part when the housing is inserted in the receiving recess.

6. The connector mounting structure according to claim 5, wherein the widened part is configured to be clamped by a pair of inclined wall portions formed on an inlet side of the pouch-like part when the housing is inserted in the receiving recess.

7. The connector mounting structure according to claim 1, wherein the housing has shoulder surfaces configured to be disposed to face an outer edge of the bipolar plate on both side portions of the receiving recess in a state in which the housing is inserted in the receiving recess, and
the at least one grasping mechanism includes a projecting piece provided on the housing to project from one of the shoulder surfaces and configured to be grasped by a pair of the bipolar plates that are adjacent to each other when the housing is inserted in the receiving recess.

8. The connector mounting structure according to claim 7, wherein the pair of the bipolar plates are formed with protruding ribs that protrude so as to reduce a distance therebetween in vicinity of outer edges thereof, and
the projecting piece is provided with a widened part configured to be disposed on an inner side of the protruding ribs and to engage with the protruding ribs when the housing is inserted in the receiving recess.
